(19) United States
(12) Patent Application Publication
(10) Pub. No.: US 2026/0071489 A1
(43) Pub. Date: Mar. 12, 2026

(54) BEAD CHAIN HOLDING DEVICE FOR BLIND

(71) Applicant: ALL WANG LIMITED, Taipei (TW)

(72) Inventors: Chih-Yung WANG, Taipei (TW); Chao-Ying CHEN, Pingtung County (TW)

(21) Appl. No.: 18/882,522

(22) Filed: Sep. 11, 2024

(51) Int. Cl. E06B 9/80; E06B 9/42; E06B 9/78

(52) U.S. Cl. CPC E06B 9/80; E06B 9/42; E06B 9/78; E06B 2009/801

(57) ABSTRACT

A bead chain holding device, comprising a holder, a bead chain wheel and a knob. The holder comprises a space inside the holder, the space is provided for the bead chain wheel corresponding to a movement of a bead chain, a first side of the holder is connected to a protruding frame, and a second side of the holder comprises a hollow portion, a first lock portion, and an engage portion protruding toward the knob. The bead chain wheel comprises a spring presser at a side of the wheel body and a second lock portion at the other side of the wheel body. The knob comprises a protruding body; by pressing and rotating the knob to compress the spring presser to disengage the second lock portion from the first lock portion but engage the protruding body with the engage portion to unlock the bead chain wheel.

### FIELD OF THE INVENTION

The invention relates to a bead chain holding device, and more particularly to a bead chain holding device for a blind improve a bead chain safety by efficiently locking a bead chain wheel to prevent a bead chain from pulling or unlocking the bead chain wheel to pull the bead chain.

### BACKGROUND OF THE INVENTION

In the community home, office doors and windows and other places, used to achieve the sun blocking and decorative function of blind curtain has become quite popular phenomenon. Please refer to FIG. 1, a blind piece 11 of an existing blind 1 uses a bead chain pull cord 12 to control the winding or downward pulling. However, the blind 1 of the bead chain pull cord 12 is not fixed, and the bead chain pull cord 12 will be swinging, hitting a wall or making noises when the wind blows into a room, or children often play with or even pull off the bead chain pull cord 12 when they are at home, and causing injuries or even getting wrapped around their necks, which is dangerous.

Currently, curtain manufacturers will attach a fixing device 2 to fix the bead chain pull cord 12 when selling the curtain 1. As disclosed in TW M581874, an improved safety fixing device for bead chain pull cord, please refer to FIG. 2. When the blind 1 is installed, a fixing device 2 is locked on the wall or other objects. However, the fixing device 2 has the following disadvantages after use: although the fixing device 2 can prevent the bead chain pull cord 12 from swinging but is not completely fixed, it can still be rotated to retract or pull down the blind. Children are capable of playing with or pulling off the bead chain pull cord, reducing the service life of blind 1 and thereby affecting its overall practicality. In this case, further improvement is needed.

### SUMMARY OF THE INVENTION

A main object of the invention is to disclose a bead chain holding device that allows consumers to effectively lock the bead chain wheel to prevent the bead chain from being pulled or unlocked. In addition to being safe, it will also reduce children's interest in playing with the bead chain to increase a service life of a blind.

In order to achieve the above object, the invention provides a bead chain holding device, comprising a holder, a bead chain wheel and a knob, wherein the holder comprises a space inside the holder, the space is provided for the bead chain wheel corresponding to a movement of a bead chain, a first side of the holder is connected to a protruding frame comprising an accommodating portion, and a second side of the holder comprises a hollow portion, a first lock portion adjacent the hollow portion and facing the first side, and an engage portion protruding toward the knob; the bead chain wheel comprises a spring presser at a side and a second lock portion at the other side thereof, the spring presser is disposed in the accommodating portion, the second lock portion is configured to engage or disengage with the first lock portion; the knob comprises a protruding body at a side of the knob near the holder, the protruding body is configured to engage or disengage with the engage portion. The bead chain holding device is configured to unlock the bead chain wheel to enable the bead chain to be pulled by pressing and rotating the knob to compress the spring presser to disengage the second lock portion from the first lock portion and engage the protruding body with the engage portion; and the bead chain holding device is configured to lock the bead chain wheel to prevent the bead chain from being pulled by rotating and releasing the knob to disengage the protruding body from the engage portion and releasing the spring presser to push the bead chain wheel to engage the second lock portion with the first lock portion.

Further, the holder comprises a base and a cover connected with the base, a side of the base is provided with the protruding frame, the base comprises two first fixers at a peripheral of the base and opposite to each other, each of the two first fixers comprises a hook piece, a first fixing hole, and two embedded holes, the two hook pieces are vertically disposed at a side of the two first fixers respectively, the two first fixing holes are disposed at a side of the two hook pieces respectively, the four embedded holes are disposed at a side of the two first fixing holes respectively, a center of the cover is disposed with the hollow portion and the first lock portion adjacent the hollow portion and facing the base, the first lock portion comprises a plurality of tapered ribs and a plurality of tapered slots, the cover comprises two second fixers at a peripheral of the cover and connected with the two first fixers, each of the two second fixers comprises a hook slot, a second fixing hole, and two embedding rods, the two hook slots are disposed at an upper end and a lower end of the two second fixers and connected with the two hook pieces respectively, the two second fixing holes are disposed at a side of the two hook slots and correspond to the two first fixing holes respectively, the four embedded rods are disposed at a side of the two second fixing holes and embedded in the four embedded holes respectively, a fastener penetrates through one of the two first fixing holes and one of the two second fixing holes to connect the cover with the base, a side of the cover facing the knob is disposed with the engage portion, the engage portion comprises two tapered engage bodies opposite to each other, the two tapered engage bodies communicate with two of the plurality of tapered slots corresponding to the two second fixers, and two opposite sides of each of the two tapered engage bodies comprises an engage slot and a sidewall respectively.

Further, the bead chain wheel comprises a wheel body in the space of the holder, a spring presser at a side of the wheel body, and the second lock portion at an other side of the wheel body.

Further, a peripheral of the wheel body is disposed with a plurality of the bead chain slots for accommodating the bead chain, a center of the wheel body is disposed with a recess slot facing the base, the recess slot is disposed with a protruding rod therein, the protruding rod protrudes toward the cover, the protruding rod comprises a first rod portion, a second rod portion connected to an end of the first rod portion, and a third rod portion connected to an end of the second rod portion, the first rod portion protrudes toward the base, the second rod portion and the third rod portion protrude toward the cover and penetrate the hollow portion of the cover, the first rod portion, the second rod portion and the third rod portion of the protruding rod are disposed with a first hole and a second hole therein, the first hole communicates with the second hole, an abutting portion is formed between the first hole and the second hole, an outer diameter of the first rod portion is larger than an outer diameter of the second rod portion, and the third rod portion is a square shape.

Further, the spring presser comprises a cap and a spring, an end of the cap is disposed in the accommodating portion of the base, the cap comprises an accommodating slot facing the first rod portion of the protruding rod, a positioning rod protruding from a center of the accommodating slot, and a plurality of positioning hooks at a peripheral of the cap, the plurality of the positioning hooks engage with the first rod portion of the protruding rod respectively, a first end of the spring is sleeved on the positioning rod, and a second end of the spring is disposed in the first hole of the protruding rod, such that the spring is compressed and expends between the abutting portion of the protruding rod and the accommodating slot of the cap.

Further, the second lock portion connects with the second rod portion of the protruding rod and is disposed in the recess slot, the second lock portion comprises a plurality of tapered columns spaced apart, the plurality of tapered columns are engaged with the plurality of tapered slots of the first lock portion respectively, such that the first lock portion is locked with the second lock portion, and the bead chain wheel is fixed.

Further, the knob comprises a protruding sleeve protruding toward the cover, and the protruding body connected to a peripheral of the protruding sleeve, wherein the protruding sleeve comprises a placing slot, an annular slot around the placing slot, and a protruding column at a center of the placing slot, an outer diameter of the annular slot is larger than an outer diameter of the placing slot, the protruding column is embedded with the second hole of the protruding rod, the second rod portion of the protruding rod abuts the annular slot, a fixing element penetrates through the second hole and the first hole of the protruding rod and is fixed on the protruding column, such that the protruding sleeve of the knob is capable of rotating relative to an outer surface of the second rod portion of the protruding rod, the protruding body comprises two tapered bodies disposed on a peripheral of the protruding sleeve and opposite to each other, each of the two tapered bodies comprises an embedding end which has a thickness variation from large to small, and each of the two embedding ends engages with one of the two engage slot of the two tapered engage bodies and abuts one of the two sidewalls, such that the two tapered bodies of the protruding body are capable of rotating to engage or disengage with the two engage slots of the engage portion.

Further, the knob further comprises a recess surface at a side of the knob opposite to the protruding sleeve, and a friction surface around a peripheral of the knob, and a peripheral of the recess surface is provided with two through holes corresponding to the two tapered engage body.

Through the foregoing implementation of the invention, compared with the prior art, the invention has the following characteristics: the bead chain holding device is configured to unlock the bead chain wheel to enable the bead chain to be pulled by pressing and rotating the knob to compress the spring presser to disengage the second lock portion from the first lock portion and engage the protruding body with the engage portion; and the bead chain holding device is configured to lock the bead chain wheel to prevent the bead chain from being pulled by rotating and releasing the knob to disengage the protruding body from the engage portion and releasing the spring presser to push the bead chain wheel to engage the second lock portion with the first lock portion. In addition to being safe, it will also reduce children's interest in playing with the bead chain to increase a service life of a blind.

### BRIEF DESCRIPTION OF THE DRAWINGS

FIG. 1 is a schematic diagram of a configuration of a bead chain pull cord and a holding device of TW M581874.

FIG. 2 is a schematic diagram of the bead chain pull cord and the holding device of TW M581874 assembled.

FIG. 3 is a schematic diagram of a configuration of a bead chain holding device of the invention.

FIG. 4 is an exploded view of the bead chain holding device of the invention.

FIG. 5 is an exploded view of another angle of the bead chain holding device of the invention.

FIG. 6 is a schematic diagram of a knob of the bead chain holding device of the invention.

FIG. 7 is a schematic side view of the knob of the bead chain holding device in FIG. 6 of the invention.

FIG. 8 is a schematic diagram of pressing and rotating the knob of the bead chain holding device in FIG. 6 of the invention.

FIG. 9A is a front view of a bead chain wheel in an unlocked state of the bead chain holding device of the invention.

FIG. 9B is a side view of the bead chain wheel in the unlocked state of the bead chain holding device in FIG. 9A of the invention.

FIG. 10 is a schematic diagram of the bead chain wheel pulling a bead chain after unlocking in FIG. 9B of the invention.

FIG. 11 is a schematic diagram of rotating the knob of the bead chain holding device of the invention.

FIG. 12 is a schematic side view of rotating the knob of the bead chain holding device in FIG. 11 of the invention.

FIG. 13A is a front view of the bead chain wheel in a locked state of the bead chain holding device of the invention.

FIG. 13B is a cross-sectional view of FIG. 13A of the invention.

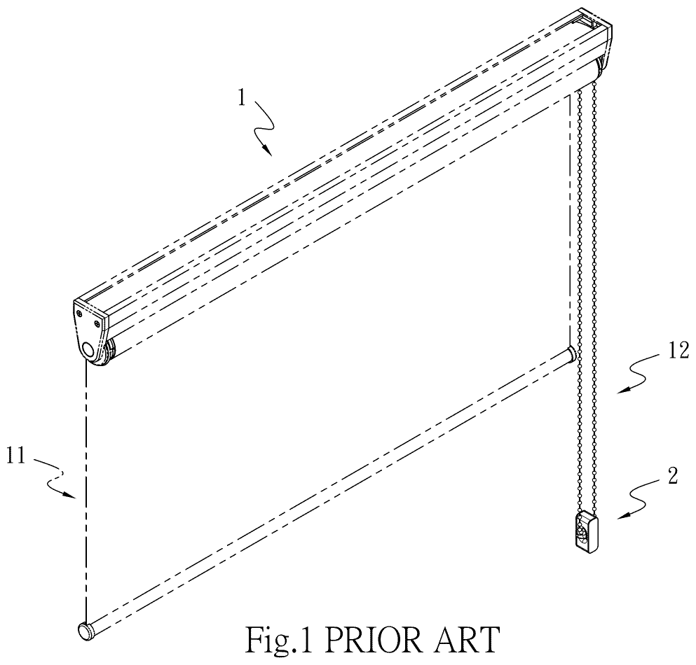

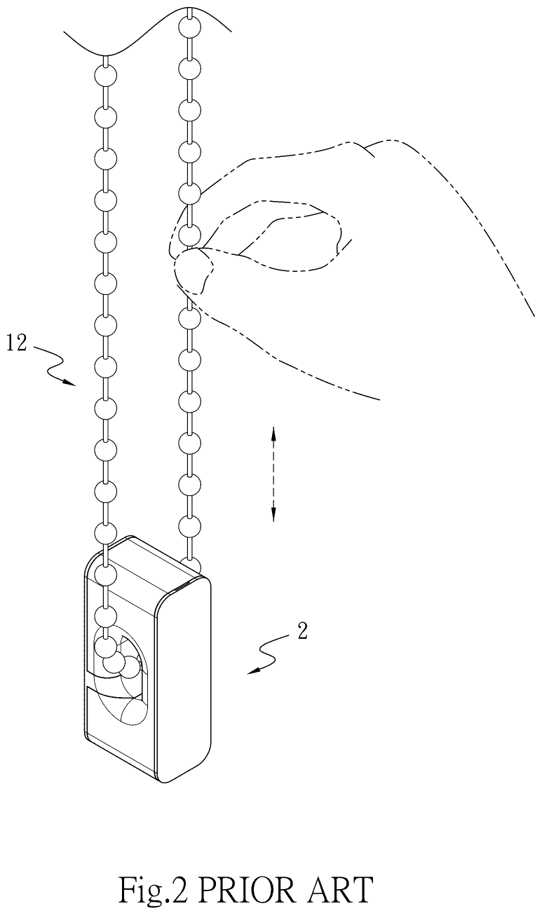

### DETAILED DESCRIPTION OF THE PREFERRED EMBODIMENTS

The detailed description and technical content of the invention are described below with reference to the accompanying drawings.

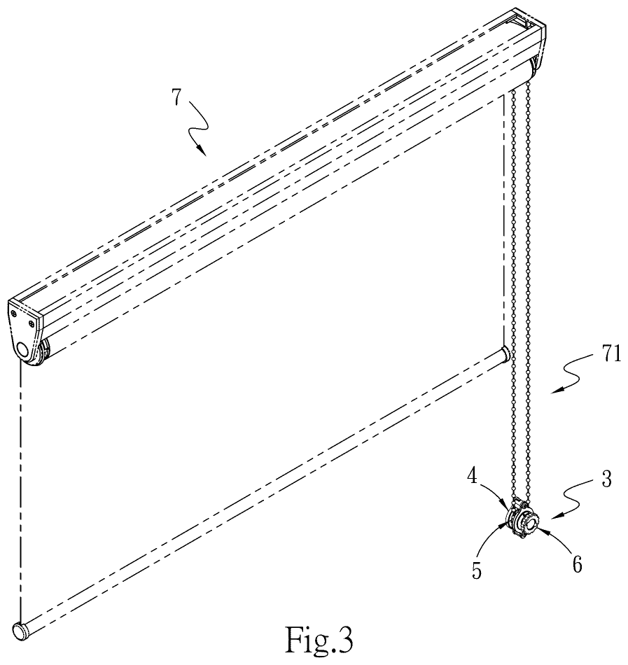

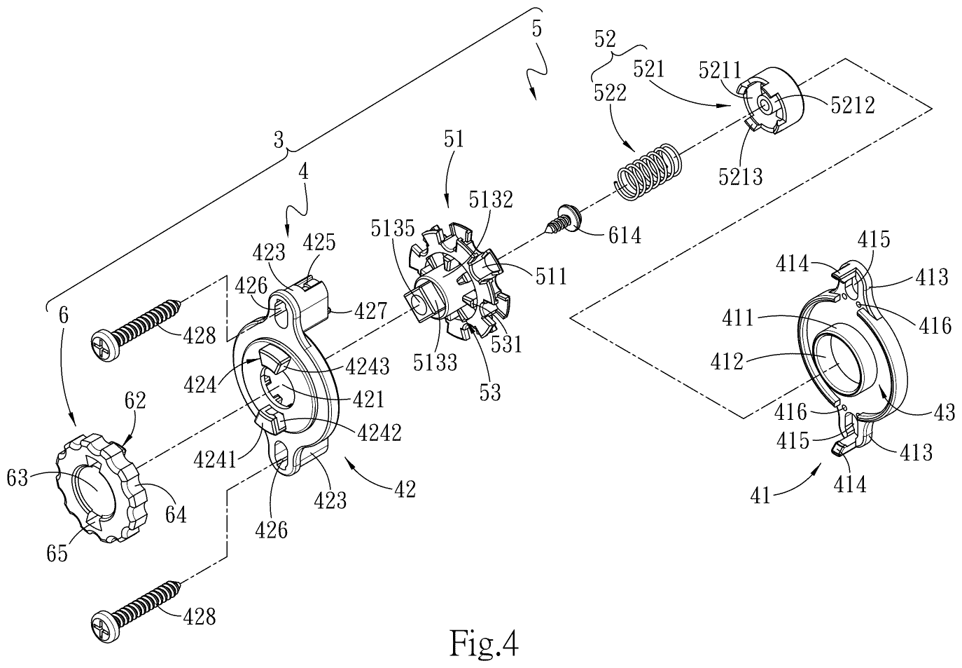

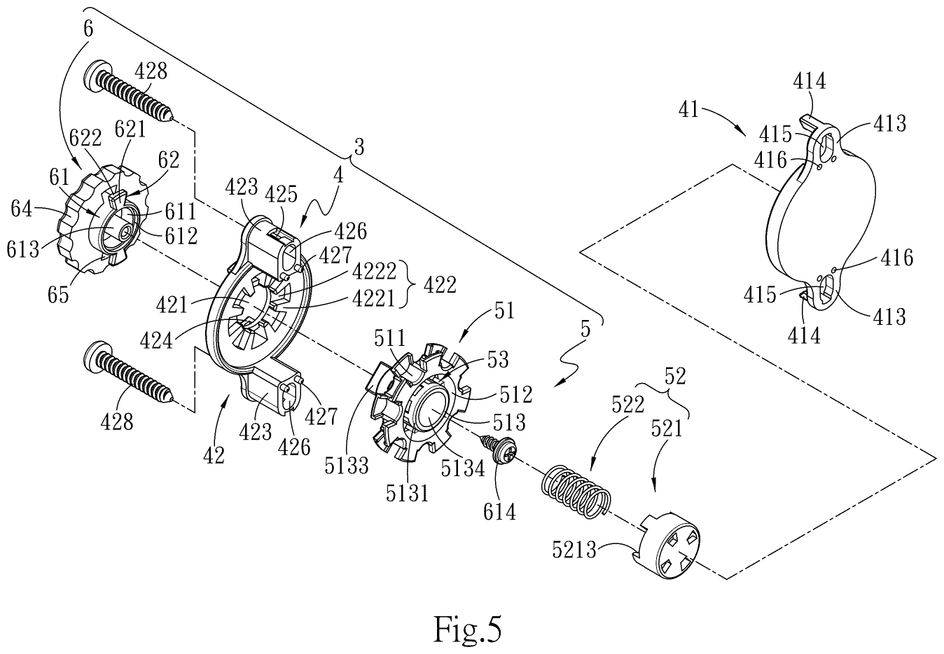

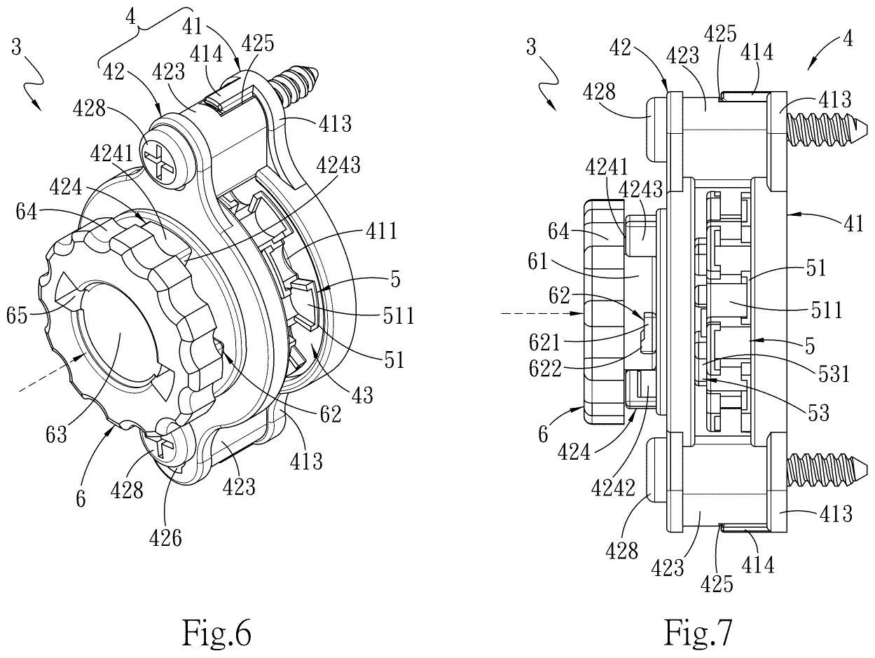

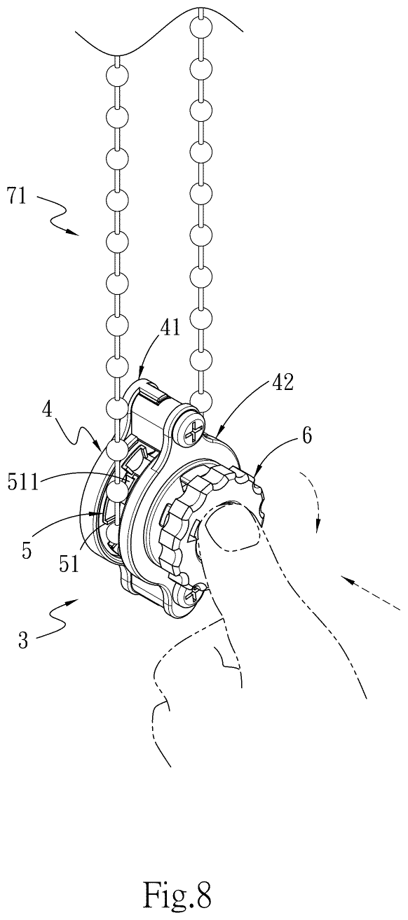

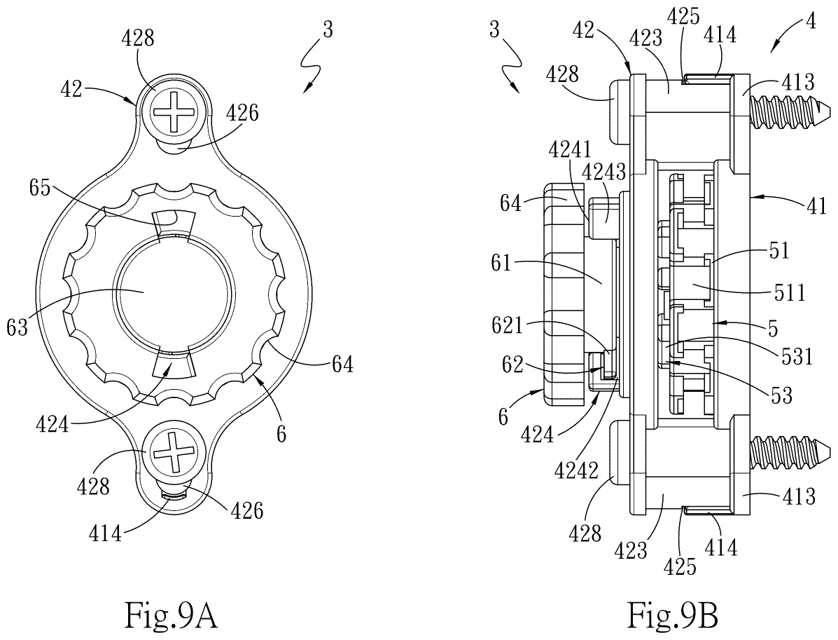

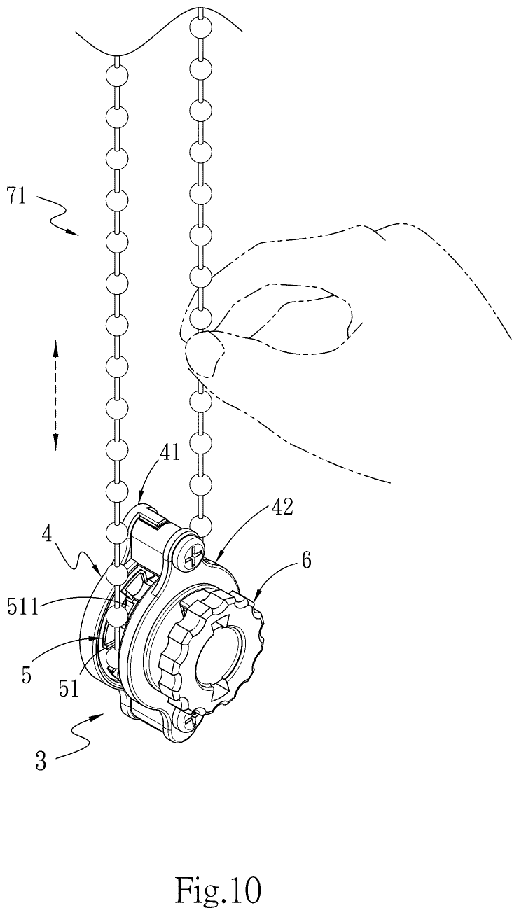

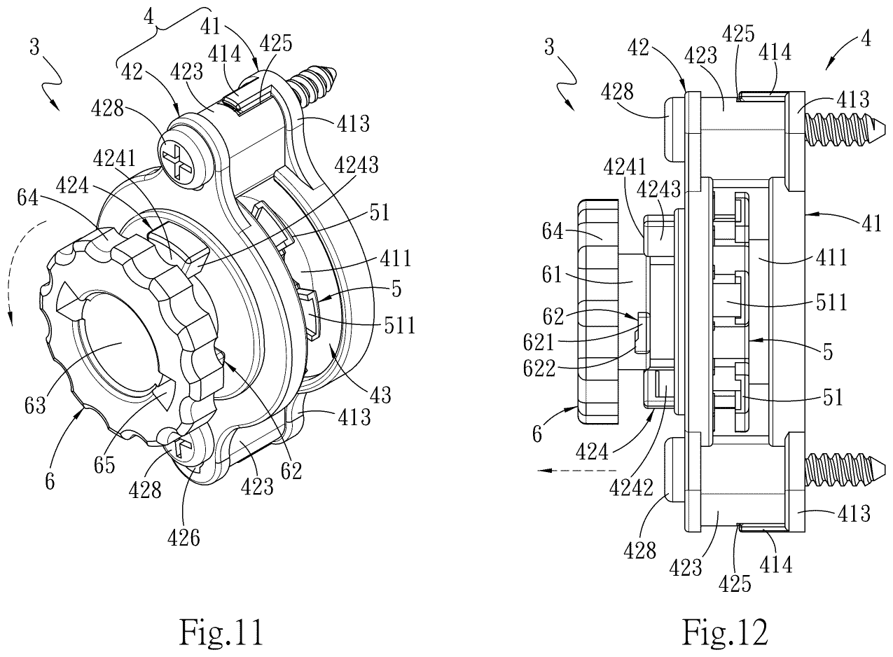

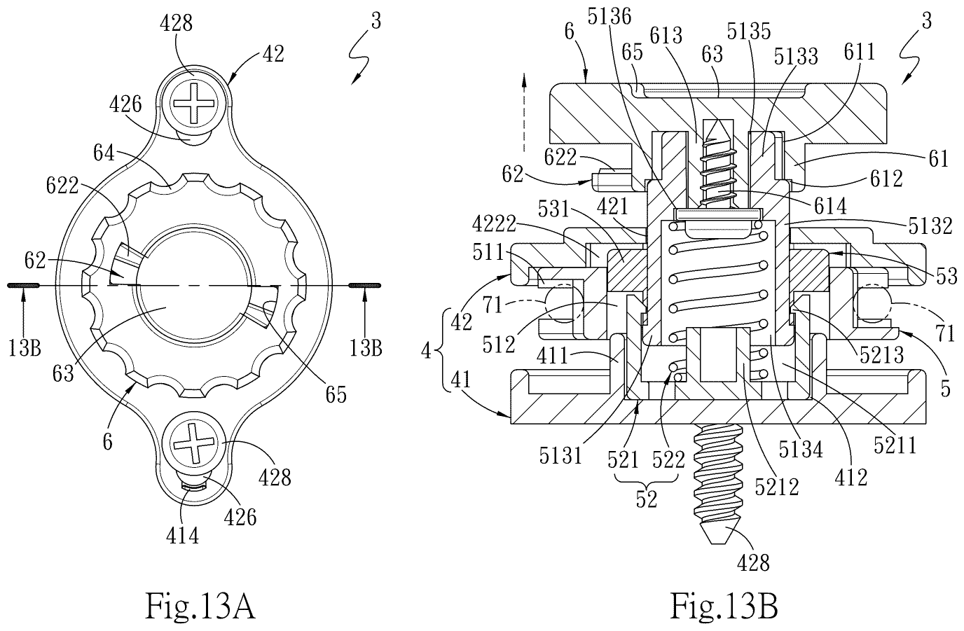

Please refer to FIG. 3, FIG. 4, FIG. 5, FIG. 6, FIG. 7, FIG. 8, FIG. 9A, FIG. 9B, FIG. 10, FIG. 11, FIG. 12, FIG. 13A, and FIG. 13B, the invention is related to a bead chain holding device for a blind. A bead chain holding device 3 comprises a holder 4, a bean chain wheel 5, and a knob 6. The knob 6 of the bead chain holding device 3 is provided for locking or unlocking a bead chain 71 of a blind 7, which is convenient for consumers to fix and safely use the bead chain 71 of the blind 7.

The holder 4 includes a base 41 and a cover 42 connected to the base 41. The holder 4 also includes a space 43 to accommodate the bead chain wheel 5. A first side of the base 41 is connected to a protruding frame 411 including an accommodating portion 412. The base 41 comprises two first fixers 413 at a peripheral of the base 41 and opposite to each other, each of the two first fixers 413 comprises a hook piece 414, a first fixing hole 415, and two embedded holes 416. The two hook pieces 414 are vertically disposed at a side of the two first fixers 413 respectively, the two first fixing holes 415 are disposed at a side of the two hook pieces 414 respectively, the four embedded holes 416 are disposed at a side of the two first fixing holes 415 respectively.

A center of the cover 42 is disposed with a hollow portion 421 and a first lock portion 422 adjacent the hollow portion 421 and facing the base 41. The cover 42 includes two second fixers 423 at a peripheral of the cover and is connected with the two first fixers 413. The two first fixers 413 may be engaged with the two second fixers 423 by snapping, screwing, embedding or riveting. A side of the cover 42 facing the knob 6 is disposed with an engage portion 424. In an embodiment, the first lock portion 422 comprises a plurality of tapered ribs 4221 and a plurality of tapered slots 4222. Each of the two second fixers 423 comprises a hook slot 425, a second fixing hole 426, and two embedding rods 427, the two hook slots 425 are disposed at an upper end and a lower end of the two second fixers 423 and connected with the two hook pieces 414 respectively. The two second fixing holes 426 are disposed at a side of the two hook slots 425 and correspond to the two first fixing holes 415 respectively. The four embedded rods 427 are disposed at a side of the two second fixing holes 426 and embedded in the four embedded holes 416 respectively, and a fastener 428 such as screw penetrates through one of the two second fixing holes 426 and one of two first fixing holes 415 to connect the cover 42 with the base 41 to fix to a wall or a surface of an object. In an embodiment, two fasteners 428 are provided. In an actual structure, the engage portion 424 comprises two tapered engage bodies 4241 opposite to each other, the two tapered engage bodies 4241 communicate with two of the plurality of tapered slots 4222 corresponding to the two second fixers 423, and two opposite sides of each of the two tapered engage bodies 4241 comprises an engage slot 4242 and a sidewall 4243 respectively.

The bead chain wheel 5 comprises a wheel body 51 in the space 43 of the holder 4, a spring presser 52 at a side of the wheel body 51, and a second lock portion 53 at the other side of the wheel body 51.

In an embodiment, a peripheral of the wheel body 51 is disposed with a plurality of the bead chain slots 511 for accommodating the bead chain 71, and a center of the wheel body 51 is disposed with a recess slot 512 facing the base 41. The recess slot 512 is disposed with a protruding rod 513 therein, and the protruding rod 513 protrudes toward the cover 42. The protruding rod 513 comprises a first rod portion 5131, a second rod portion 5132 connected to an end of the first rod portion 5131, and a third rod portion 5133 connected to an end of the second rod portion 5132. The first rod portion 5131 protrudes toward the base 41, and the second rod portion 5132 and the third rod portion 5133 protrude toward the cover 42 and penetrate the hollow portion 421 of the cover 42. The first rod portion 5131, the second rod portion 5132 and the third rod portion 5133 of the protruding rod 513 are disposed with a first hole 5134 and a second hole 5135 therein, and the first hole 5134 communicates with the second hole 5135. An abutting portion 5136 is formed between the first hole 5134 and the second hole 5135. An outer diameter of the first rod portion 5131 is larger than an outer diameter of the second rod portion 5132, and the third rod portion 5133 is a square shape.

The spring presser 52 comprises a cap 521 and a spring 522. An end of the cap 521 is disposed in the accommodating portion 412 of the base 41. The cap 521 comprises an accommodating slot 5211 facing the first rod portion 5131 of the protruding rod 513, a positioning rod 5212 protruding from a center of the accommodating slot 5211, and a plurality of positioning hooks 5213 at a peripheral of the cap 521, the plurality of the positioning hooks 5213 engage with the first rod portion 5131 of the protruding rod 513 respectively. A first end of the spring 522 is sleeved on the positioning rod 5212, and a second end of the spring 522 is disposed in the first hole 5134 of the protruding rod 513, such that the spring 522 is compressed and expends between the abutting portion 5136 of the protruding rod 513 and the accommodating slot 5211 of the cap 521, to prevent the spring 522 from skewing or deflecting.

The second lock portion 53 connects with the second rod portion 5132 of the protruding rod 513 and is disposed in the recess slot 512. The second lock portion 53 comprises a plurality of tapered columns 531 spaced apart, and the plurality of tapered columns 531 are engaged with the plurality of tapered slots 4222 of the first lock portion 422 respectively, such that the first lock portion 422 is locked with the second lock portion 53, and the bead chain wheel 5 is fixed.

The knob 6 comprises a protruding sleeve 61 protruding toward the cover 42, and the protruding body 62 connected to a peripheral of the protruding sleeve 61, wherein the protruding sleeve 61 comprises a placing slot 611, an annular slot 612 around the placing slot 611, and a protruding column 613 at a center of the placing slot 611. An outer diameter of the annular slot 612 is larger than an outer diameter of the placing slot 611, and the protruding column 613 is embedded with the second hole 5135 of the protruding rod 513. The second rod portion 5132 of the protruding rod 513 abuts the annular slot 612, and a fixing element 614 such as screw penetrates through the second hole 5135 and the first hole 5134 of the protruding rod 513 and is fixed on the protruding column 613, such that the protruding sleeve 61 of the knob 6 is capable of rotating relative to an outer surface of the second rod portion 5132 of the protruding rod 513. The protruding body 62 comprises two tapered bodies 621 disposed on a peripheral of the protruding sleeve 61 and opposite to each other, each of the two tapered bodies 621 comprises an embedding end 622 which has a thickness variation from large to small, and each of the two embedding ends 622 engages with one of the two engage slot 4242 of the two tapered engage bodies 4241 and abuts one of the two sidewalls 4243, such that the two tapered bodies 621 of the protruding body 62 are capable of rotating to engage or disengage with the two engage slots 4242 of the engage portion 424.

Please refer to FIG. 5, FIG. 9A, and FIG. 13A. The knob 6 further comprises a recess surface 63 at a side of the knob 6 opposite to the protruding sleeve 61, and a friction surface 64 around a peripheral of the knob 6, which are convenient for pressing and rotating by hand. A peripheral of the recess surface 63 is provided with two through holes 65 corresponding to the two tapered bodies 621, such that the two tapered bodies 621 of the protruding body 62 are rotated to engage or disengage with the two engage slots 4242 of the engage portion 424 can be observed through the two through holes 65.

Please refer to FIG. 3, FIG. 4, FIG. 5, FIG. 6, FIG. 7, FIG. 8, FIG. 9A, and FIG. 9B. The bead chain holding device 3 is fixed to the wall or the surface of the object after assembly, when the consumers intended to pull the bead chain 71, by pressing and rotating the knob 6 to compress the spring presser 52, the two tapered bodies 621 rotate to engage with the two engage slot 4242 of the two tapered engage bodies 4241 respectively, such that the plurality of tapered columns 531 are disengaged with the plurality of tapered slots 4222 of the first lock portion 422 respectively, and the bead chain wheel 5 is unlocked for the bead chain 71 to be pulled, as shown in FIG. 10. When the bead chain wheel 5 is intended to be locked, as shown in FIG. 11, FIG. 12, FIG. 13A, and FIG. 13B, the two tapered bodies 621 rotate to disengage with the two engage slot 4242 of the two tapered engage bodies 4241 respectively, the plurality of tapered columns 531 of the second lock portion 53 are engaged with the plurality of tapered slots 4222 of the first lock portion 422 by a restoring force of the spring 522, to lock the bead chain wheel 5 and prevent the bead chain 71 from being pulled. In addition to being safe, it will also reduce children's interest in playing with the bead chain 71 to increase a service life of a blind 7.

What is claimed is:

1. A bead chain holding device, provided for a blind, and the bead chain holding comprising a holder, a bead chain wheel and a knob, wherein,
the holder comprises a space therein, wherein the space is provided for the bead chain wheel corresponding to a movement of a bead chain, a first side of the holder is connected to a protruding frame comprising an accommodating portion, and a second side of the holder comprises a hollow portion, a first lock portion adjacent the hollow portion and facing the first side, and an engage portion protruding toward the knob;
the bead chain wheel comprises a spring presser at a side of the bead chain wheel and a second lock portion at an other side of the bead chain wheel, wherein the spring presser is disposed in the accommodating portion, and the second lock portion is configured to engage or disengage with the first lock portion; and
the knob comprises a protruding body at a side of the knob near the holder, wherein the protruding body is configured to engage or disengage with the engage portion,
wherein the bead chain holding device is configured to unlock the bead chain wheel to enable the bead chain to be pulled by pressing and rotating the knob to compress the spring presser to disengage the second lock portion from the first lock portion and engage the protruding body with the engage portion; and the bead chain holding device is configured to lock the bead chain wheel to prevent the bead chain from being pulled by rotating and releasing the knob to disengage the protruding body from the engage portion and releasing the spring presser to push the bead chain wheel to engage the second lock portion with the first lock portion.

2. The bead chain holding device as claimed in claim 1, wherein the holder comprises a base and a cover connected with the base, a side of the base is provided with the protruding frame, the base comprises two first fixers at a peripheral of the base and opposite to each other, each of the two first fixers comprises a hook piece, a first fixing hole, and two embedded holes, wherein in each first fixer, the hook pieces is vertically disposed at a side of the first fixer, the first fixing hole is disposed at a side of the hook piece, the two embedded holes are disposed at a side of the first fixing hole, a center of the cover is disposed with the hollow portion and the first lock portion adjacent the hollow portion and facing the base, the first lock portion comprises a plurality of tapered ribs and a plurality of tapered slots, the cover comprises two second fixers at a peripheral of the cover and connected with the two first fixers, each of the two second fixers comprises a hook slot, a second fixing hole, and two embedding rods, wherein in each second fixer, the hook slot is disposed at an upper end and a lower end of the second fixer and connected with the hook piece, the second fixing hole is disposed at a side of the hook slot and correspond to the first fixing hole, the two embedded rods are disposed at a side of the second fixing hole and embedded in the two embedded holes respectively, a fastener penetrates through one of the two first fixing holes and one of the two second fixing holes to connect the cover with the base, a side of the cover facing the knob is disposed with the engage portion, the engage portion comprises two tapered engage bodies opposite to each other, the two tapered engage bodies communicate with two of the plurality of tapered slots corresponding to the two second fixers, and two opposite sides of each of the two tapered engage bodies comprises an engage slot and a sidewall respectively.

3. The bead chain holding device as claimed in claim 2, wherein the bead chain wheel comprises a wheel body in the space of the holder, the spring presser at a side of the wheel body, and the second lock portion at an other side of the wheel body.

4. The bead chain holding device as claimed in claim 3, wherein a peripheral of the wheel body is disposed with a plurality of the bead chain slots for accommodating the bead chain, a center of the wheel body is disposed with a recess slot facing the base, the recess slot is disposed with a protruding rod therein, the protruding rod protrudes toward the cover, the protruding rod comprises a first rod portion, a second rod portion connected to an end of the first rod portion, and a third rod portion connected to an end of the second rod portion, the first rod portion protrudes toward the base, the second rod portion and the third rod portion protrude toward the cover and penetrate the hollow portion of the cover, the first rod portion, the second rod portion and the third rod portion of the protruding rod are disposed with a first hole and a second hole therein, the first hole communicates with the second hole, an abutting portion is formed between the first hole and the second hole, an outer diameter of the first rod portion is larger than an outer diameter of the second rod portion, and the third rod portion is a square shape.

5. The bead chain holding device as claimed in claim 4, wherein the spring presser comprises a cap and a spring, an end of the cap is disposed in the accommodating portion of the base, the cap comprises an accommodating slot facing the first rod portion of the protruding rod, a positioning rod protruding from a center of the accommodating slot, and a plurality of positioning hooks at a peripheral of the cap, the plurality of the positioning hooks engage with the first rod portion of the protruding rod respectively, a first end of the spring is sleeved on the positioning rod, and a second end of the spring is disposed in the first hole of the protruding rod, such that the spring is compressed and expends between the abutting portion of the protruding rod and the accommodating slot of the cap.

6. The bead chain holding device as claimed in claim 5, wherein the second lock portion connects with the second rod portion of the protruding rod and is disposed in the recess slot, the second lock portion comprises a plurality of tapered columns spaced apart, the plurality of tapered columns are engaged with the plurality of tapered slots of the first lock portion respectively, such that the first lock portion is locked with the second lock portion, and the bead chain wheel is fixed.

7. The bead chain holding device as claimed in claim 6, wherein the knob comprises a protruding sleeve protruding toward the cover, and the protruding body connected to a peripheral of the protruding sleeve, wherein the protruding sleeve comprises a placing slot, an annular slot around the placing slot, and a protruding column at a center of the placing slot, an outer diameter of the annular slot is larger than an outer diameter of the placing slot, the protruding column is embedded with the second hole of the protruding rod, the second rod portion of the protruding rod abuts the annular slot, a fixing element penetrates through the second hole and the first hole of the protruding rod and is fixed on the protruding column, such that the protruding sleeve of the knob is capable of rotating relative to an outer surface of the second rod portion of the protruding rod, the protruding body comprises two tapered bodies disposed on a peripheral of the protruding sleeve and opposite to each other, each of the two tapered bodies comprises an embedding end which has a thickness variation from large to small, and each of the two embedding ends engages with the engage slot of one of the two tapered engage bodies and abuts one of the two sidewalls, such that the two tapered bodies of the protruding body are capable of rotating to engage or disengage with the engage slot of each of the two tapered engage bodies of the engage portion.

8. The bead chain holding device as claimed in claim 7, wherein the knob further comprises a recess surface at a side of the knob opposite to the protruding sleeve, and a friction surface around a peripheral of the knob, and a peripheral of the recess surface is provided with two through holes corresponding to the two tapered engage bodies.
